(19) United States
(12) Patent Application Publication
(10) Pub. No.: US 2022/0002938 A1
(43) Pub. Date: Jan. 6, 2022

(54) Method for anti-felting finishing of wool fabric with protease K

(71) Applicant: Jiangnan University, Wuxi (CN)

(72) Inventors: Qiang Wang, Wuxi (CN); Wenjia Li, Wuxi (CN); Yuanyuan Yu, Wuxi (CN); Jiugang Yuan, Wuxi (CN); Ping Wang, Wuxi (CN); Xuerong Fan, Wuxi (CN)

(21) Appl. No.: 17/475,423

(22) Filed: Sep. 15, 2021

Related U.S. Application Data
(63) Continuation of application No. PCT/CN2020/075480, filed on Feb. 17, 2020.

(30) Foreign Application Priority Data
Mar. 15, 2019 (CN) 2019101968686

(51) Int. Cl. D06M 16/00; D06M 13/432; D06M 11/72; D06M 15/03

(52) U.S. Cl. CPC D06M 16/003; D06M 13/432; D06M 2101/12; D06M 15/03; C12Y 304/21064; D06M 11/72

(57) ABSTRACT

The disclosure discloses a method for anti-felting finishing of wool fabric with protease K, and belongs to the technical field of dyeing and finishing of wool fabric in the wool spinning industry. The purpose is to solve the problems that common protease anti-felting treatment has greater damage to the strength of wool and has a weak degradation effect on keratin in a scale layer, thereby achieving the purpose of optimizing the anti-felting finishing of wool fabrics with protease. A preferred process is: pure wool fabric is first pretreated with urea peroxide, CMC is blocked with chitosan oligosaccharides, and then the wool fabric is treated with protease K. The wool fabric treated by the method has obviously improved anti-felting property, and the damage to the strength of the fabric is reduced. The disclosure introduces protease K into the anti-felting finishing of wool for the first time. Through effective degradation of keratin in wool scales by the protease K, a good anti-felting effect of wool is achieved, and the protease K anti-felting treatment can replace the traditional chlorination anti-felting treatment.

### TECHNICAL FIELD

The disclosure relates to a method for anti-felting finishing of wool fabric with protease K, which belongs to the technical field of dyeing and finishing of wool fabric in the wool spinning industry.

### BACKGROUND

Wool feels plump, has strong moisture absorption capacity, is not easy to be stained and has excellent warmth retention, which is a popular high-end textile fabric. However, the special flaky structure on the surface of wool fiber results in a unique felting property of the wool, which is prone to felt when being washed. In addition, good elasticity and crimp tendency of wool also promote felting, which affects the practicality of wool.

At present, a chlorination process is very common in anti-felting treatment of wool. The chlorination process has a very good anti-felting effect, and also improves the wettability of fabric. However, the chlorination process has great damage to wool, the fabric is easy to turn yellow after treatment, and the process pollutes the environment. Enzymatic anti-felting finishing of wool has always been the focus and hotspot of domestic and foreign research due to its environmental protection characteristic, which is a new technology that is most likely to replace traditional chlorination anti-felting processing. Among them, because wool is protein fiber, protease, as a type of enzyme that specifically catalyzes the hydrolysis of peptide bonds in proteins, first entered the vision of research.

Protease anti-felting finishing mainly uses the hydrolysis of enzyme molecules on wool to destroy a flaky layer, thereby achieving the purpose of anti-felting. The use conditions of protease are mild, and waste liquid is easy to degrade, which meets the requirements of environmental protection. The wool fabric treated with protease feels softer is more lustrous, and has obviously improved pilling resistance. However, the enzymatic anti-felting finishing also has many problems: because wool scales contain a large amount of disulfide bond cross-linked keratinized protein (keratin), protease will preferentially attack a non-keratinized, highly swellable cell membrane complex (CMC), further enter the inside of fiber through the intercellular space and degrade the inside of the fiber, resulting in a sharp decline in fiber strength, which greatly affects its wearing usability. Use of enzymes that directly degrade scale keratin is the key to achieving better comprehensive results (low felting rate and low strength loss) in wool anti-felting processing. At present, there have been studies on the use of keratinase to treat wool fabric in prevention of felting, but the process of keratinase treatment is very slow, usually requiring 30-50 hours, which greatly increases the time cost of industrial production.

Therefore, there is an urgent need for a new method that can not only speed up the treatment of keratin by biological enzymes, but also reduce the damage of the biological enzymes to the strength inside the wool.

### SUMMARY

To solve the problems of weak degradation on surface scale keratin, large internal strength loss of wool, and the like in the process of wool treatment with the existing protease, the disclosure provides a novel anti-felting finishing method for wool fabric by protease. On the one hand, protease K can effectively degrade keratin, so as to destroy and peel off the scale layer to a greater extent, thereby obtaining an ideal anti-felting effect on wool. On the other hand, the effect of the protease K on the wool is concentrated on the scale layer by blocking the CMC with chitosan oligosaccharides, so that the overall strength of the wool is less damaged after treatment, and the shortcomings of common proteases are overcome, achieving a good overall anti-felting effect. Protease K belongs to the class of serine proteases, and is a major protease produced by Tritirachium album Limber and the like. Because a microorganism capable of synthesizing this kind of protease can grow in an environment with keratin as the sole carbon and nitrogen source, that is, can digest keratin, the protease is named protease K. The protease K family contains various intracellular peptidases secreted by fungi, yeast and gram-negative bacteria. Compared with other proteases, protease K has high activity and high stability, and the enzyme activity will not be inhibited by denaturants such as urea, SDS and EDTA. Under conditions of high temperature, high salt, or relatively high pH, protease K can still maintain high activity. Protease K has broad substrate specificity, tends to degrade carboxy-terminal peptide bonds with aliphatic and aromatic amino acids, and has a relative molecular weight of about 29.3 kDa. Because protease K is active in a relatively wide pH range (4-12.5) and at high temperature (50-70° C.), it has high activity in a buffer for extracting DNA and RNA, can be used for isolation of plasmids or genomic DNA and RNA, and is a key reagent for DNA extraction.

The disclosure discloses a method for anti-felting finishing of wool fabric with protease K, which includes the following steps: pretreating wool fabric or wool fiber with urea peroxide, blocking a cell membrane complex CMC with chitosan oligosaccharides, then treating the wool fabric or wool fiber with protease K, and washing the wool fabric or wool fiber with water. The blocking of the cell membrane complex CMC with the chitosan oligosaccharides means that the chitosan oligosaccharides are bonded to the cell membrane complex CMC by ionic bonds and hydrogen bonds.

In an embodiment of the disclosure, the method includes the following specific steps:

(1) pretreatment of fabric with urea peroxide: immersing wool fabric or wool fiber in 80-100° C. hot water for 0.5-1 h and taking it out; then treating the wool fabric or wool fiber in a solution containing urea peroxide 10-50 mL/L, sodium pyrophosphate 1-3 g/L and a penetrant JFC 0.5-2 g/L at a liquor ratio of (20-50):1, a temperature of 40-70° C., and a pH of 5-9 for 1-4 h; after finishing, washing the wool fabric or wool fiber with water, and drying the wool fabric or wool fiber at 50-60° C.;

(2) treatment of fabric with protease K: immersing the wool fabric or wool fiber pretreated in step (1) in 40-65° C. hot water containing chitosan oligosaccharides 0.5-2 g/L and urea 10-50 g/L at a liquor ratio of (20-50):1 for 0.5-1 h, and then immersing the wool fabric or wool fiber in a protease K solution at a temperature of 80-95° C., a pH of 6-10, and a liquor ratio of (20-50):1 for 2-24 h; and

(3) enzyme inactivation: inactivating the protease K, finally washing the wool fabric or wool fiber with water, and drying the wool fabric or wool fiber.

In an embodiment of the disclosure, Ca²⁺ 0.5-2 mmol/L is added to the protease K solution.

In an embodiment of the disclosure, in step (3), the wool fabric or wool fiber after enzyme inactivation is washed with 90-100° C. hot water and normal temperature water sequentially once or twice.

In an embodiment of the disclosure, for enzyme inactivation, trichloroacetic acid 0.5-5.0 mol/L is added to the protease K solution to inactivate the protease K, or the temperature of the protease K solution can be raised to 80-90° C. for treatment for 10-30 min.

In an embodiment of the disclosure, the amount of the protease K added is 2-32 U/g_{fabric/fiber}, preferably 2-16 U/g_{fabric/fiber}.

In an embodiment of the disclosure, the treatment time of the protease K is preferably 2-6 h.

In an embodiment of the disclosure, the wool fabrics include any one of all-wool gabardine, serge, and valitin worsted woolen fabric, or any one of all-wool gabardine, serge, and valitin woolen fabric.

In an embodiment of the disclosure, the urea peroxide pretreatment has a greater influence on the felting property of wool fabric or fiber, and the anti-felting property of the wool fabric or fiber after pretreatment is improved to a greater extent.

The disclosure further provides a anti-felting finishing solution for wool fabrics. The finishing solution is divided into a solution A, a solution B and a solution C. The solution A is a solution containing urea peroxide 10-50 mL/L, sodium pyrophosphate 1-3 g/L and a penetrant JFC 0.5-2 g/L; the solution B is a solution containing chitosan oligosaccharides 0.5-2 g/L and urea 10-50 g/L; and the solution C is a protease K solution containing Ca²⁺ 0.5-2 mmol/L.

Finally, the disclosure provides a use method of the anti-felting finishing solution for wool fabrics, including: immersing wool fabric or wool fiber in 80-100° C. hot water for 0.5-1 h; then treating the wool fabric or wool fiber in the solution A at a liquor ratio of (20-50):1 and 40-70° C. for 1-4 h; after finishing, washing the wool fabric or wool fiber with water, and drying the wool fabric or wool fiber at 50-60° C.; immersing the wool fabric or wool fiber in the solution B at a liquor ratio of (20-50):1 and 40-65° C. for 0.5-1 h; and treating the wool fabric or wool fiber in the 80-95° C. solution C for 2-24 h at a liquor ratio of (20-50):1; and performing enzyme inactivation, washing with water, and drying.

### Advantages and Effects of the Disclosure

(1) The disclosure uses urea peroxide as a pretreatment method for wool fabric or wool fiber for the first time, can destroy a lipid structure of the surface layer of wool scales and part of disulfide bonds of the scales, and creates better conditions for subsequent enzymatic treatment. At the same time, compared with hydrogen peroxide pretreatment, urea produced during decomposition of urea peroxide in the treatment process can help the fiber swell, so that urea peroxide can oxidate the lipids and the surface of the scales better.

(2) Aiming at the problems of relatively weak degradation effect of common proteases on flaky keratin and slow treatment speed of keratinase, the disclosure introduces protease K into anti-felting finishing of wool for the first time, and the protease K can hydrolyze keratin and common protein at the same time, which is quite innovative.

(3) In order to prevent the protease K from attacking CMC preferentially, then entering the inside of fiber through the intercellular space and destroying fiber strength, the disclosure first uses chitosan oligosaccharides to bond to the non-keratinized cell membrane complex CMC (common protein) in wool by ionic and hydrogen bonds in advance to play a certain role of “blocking the CMC”, and then uses the protease K to perform anti-felting finishing on wool fabric by the property that the protease K can effectively degrade keratin, thereby destroying the scale layer of wool (CMC is not susceptible to enzyme digestion due to blocking), and obtaining a better anti-felting effect. At the same time, the damage to the wool strength is less.

(4) The disclosure uses urea peroxide for pretreatment and then uses protease K for treatment, realizing a anti-felting effect of the wool fabric or fiber, thereby reducing the felting degree of fabric during washing, and achieving a machine-washable effect. Compared with a traditional chlorination method, the disclosure is more in line with the requirements of modern green ecology, health and environmental protection.

### DETAILED DESCRIPTION

Weight loss rate: weight loss rate (%)=(dry weight of wool before treatment-dry weight of wool after treatment)/dry weight of wool before treatment×100%.

Felting rate: percentage reduction of area (%)=(area before washing-area after washing)/area before washing×100%.

Strength loss rate: strength loss rate (%)=(breaking strength of untreated wool-breaking strength of wool after treatment)/breaking strength of untreated wool×100%.

The protease K was purchased from Shanghai Yeasen Biotech Co., Ltd., and the product number is 10401E580.

### EXAMPLE 1

### Fabric VARIETY: ALL-WOOL GABARDINE FABRIC

(1) Pretreatment of fabric with urea peroxide: Wool fabric was immersed in 90° C. hot water for 1 h, and then the wool fabric was treated in a solution containing urea peroxide 30 mL/L, sodium pyrophosphate 1.5 g/L and a penetrant JFC 1 g/L at a liquor ratio of 35:1, a temperature of 50° C. and a pH of 8 for 1 h. Then the wool fabric was washed with water repeatedly and dried at 50° C.

(2) Treatment of fabric with protease K: The pretreated wool fabric was immersed in 90° C. hot water containing chitosan oligosaccharides 1 g/L and urea 20 g/L for 1 h, and then immersed in a protease K solution (16 U/g_{fabric}) with Ca²⁺ 1 mmol/L added, at an enzyme solution temperature of 50° C., a pH of 8 and a liquor ratio of 25:1 for 6 h.

(3) The enzyme was inactivated at 80° C. for 10 min. After finishing, the wool fabric was washed with 90° C. hot water and normal temperature water sequentially twice, and dried at 50° C.

After treatment by the above process, the wool fabric has a felting rate of 5.02%, a weight loss rate of 9.0%, and a strength loss rate of 14.1%.

Control sample: Fabric was pretreated according to step (1) in Example 1, and then the fabric was treated with protease (16 U/g_{fabric}) according to step (3). The control sample has a felting rate of 8.06%, a weight loss rate of 25.9%, and a strength loss rate of 42.70%.

### EXAMPLE 2

### Fabric Variety: Valitin Fabric

(1) Pretreatment of fabric with urea peroxide: Wool fabric was immersed in 90° C. hot water for 1 h, and then the wool fabric was treated in a solution containing urea peroxide 30 mL/L, sodium pyrophosphate 1.5 g/L and a penetrant JFC 1 g/L at a liquor ratio of 35:1, a temperature of 50° C. and a pH of 8 for 1 h. After finishing, the wool fabric was washed with deionized water repeatedly and dried at 50° C.

(2) Treatment of fabric with protease K: The pretreated wool fabric was immersed in 90° C. hot water containing chitosan oligosaccharides 1 g/L and urea 20 g/L for 1 h, and then immersed in a protease K solution (4 U/g_{fabric}) with Ca²⁺ 1 mmol/L added, at an enzyme solution temperature of 50° C., a pH of 8 and a liquor ratio of 25:1 for 4 h.

(3) The enzyme was inactivated at 80° C. for 10 min. After finishing, the wool fabric was washed with 90° C. hot water and normal temperature water sequentially twice, and dried at 50° C.

After treatment by the above process, the wool fabric has a felting rate of 5.96%, a weight loss rate of 10.65%, and a strength loss rate of 11.28%.

Control sample: Fabric was pretreated according to step (1) in Example 2, and then the fabric was treated with protease (4 U/g_{fabric}) according to step (3). The control sample has a felting rate of 7.7%, a weight loss rate of 22.3%, and a strength loss rate of 39.42%.

It can be seen that the wool fabric has a better anti-felting effect after being treated with protease K, and the strength loss is significantly reduced compared with the common protease treatment.

### EXAMPLE 3

### Fabric Variety: Valitin Fabric

(1) Pretreatment of fabric with urea peroxide: Wool fabric was immersed in 90° C. hot water for 1 h, and then the wool fabric was treated in a solution containing urea peroxide 10 mL/L, sodium pyrophosphate 2 g/L and a penetrant JFC 2 g/L at a liquor ratio of 50:1, a temperature of 70° C. and a pH of 6 for 2 h. After finishing, the wool fabric was washed with deionized water repeatedly and dried at 50° C.

(2) Treatment of fabric with protease K: The pretreated wool fabric was immersed in 90° C. hot water containing chitosan oligosaccharides 2 g/L and urea 40 g/L for 1 h, and then immersed in a protease K solution (25 U/g_{fabric}) with Ca²⁺ 2 mmol/L added, at an enzyme solution temperature of 65° C., a pH of 10 and a liquor ratio of 20:1 for 4 h.

(3) The enzyme was inactivated at 80° C. for 10 min. After finishing, the wool fabric was washed with 90° C. hot water and normal temperature water sequentially twice, and dried at 50° C.

After treatment by the above process, the wool fabric has a felting rate of 4.92%, a weight loss rate of 12.64%, and a strength loss rate of 16.47%.

### Comparative Example 1

### Fabric Variety: Valitin Fabric

(1) Treatment of fabric with protease K: Wool fabric was immersed in 90° C. hot water containing chitosan oligosaccharides 1 g/L and urea 20 g/L for 1 h, and then immersed in a protease K solution (4 U/g_{fabric}) with Ca²⁺ 1 mmol/L added, at an enzyme solution temperature of 50° C., a pH of 8 and a liquor ratio of 25:1 for 4 h.

(2) The enzyme was inactivated at 80° C. for 10 min. After finishing, the wool fabric was washed with 90° C. hot water and normal temperature water sequentially twice, and dried at 50° C.

After treatment by the above process, the wool fabric has a felting rate of 10.67%, a weight loss rate of 9.8%, and a strength loss rate of 10.2%. The anti-felting effect of the wool fabric without urea peroxide pretreatment is lower than that of the pre-treated wool fabric, and has a higher felting rate.

### Comparative Example 2

### Fabric Variety: Valitin Fabric

(1) Treatment of fabric with protease K: Wool fabric was immersed in 90° C. hot water for 1 h, and then immersed in a protease K solution (4 U/g_{fabric}) with Ca²⁺ 1 mmol/L added, at an enzyme solution temperature of 50° C., a pH of 8 and a liquor ratio of 25:1 for 4 h.

(2) The enzyme was inactivated at 80° C. for 10 min. After finishing, the wool fabric was washed with 90° C. hot water and normal temperature water sequentially twice, and dried at 50° C.

After treatment by the above process, the wool fabric has a felting rate of 12.5%, a weight loss rate of 12.1%, and a strength loss rate of 18.32%. Compared with Example 4, it can be seen that pretreatment with chitosan oligosaccharides and urea during protease K treatment can help reduce the felting rate and strength damage.

### Comparative Example 3

### Fabric Variety: Valitin Fabric

(1) Pretreatment of fabric with hydrogen peroxide: Wool fabric was immersed in 90° C. hot water for 1 h, and then the wool fabric was treated in a solution containing 30% of hydrogen peroxide solution, sodium pyrophosphate 1.5 g/L and a penetrant JFC 1 g/L at a liquor ratio of 35:1, a temperature of 50° C. and a pH of 8 for 1 h. After finishing, the wool fabric was washed with deionized water repeatedly and dried at 50° C.

(2) Treatment of fabric with protease K: The pretreated wool fabric was immersed in 90° C. hot water containing chitosan oligosaccharides 1 g/L and urea 20 g/L for 1 h, and then immersed in a protease K solution (4 U/g_{fabric}) with Ca²⁺ 1 mmol/L added, at an enzyme solution temperature of 50° C., a pH of 8 and a liquor ratio of 25:1 for 4 h.

(3) The enzyme was inactivated at 80° C. for 10 min. Then the wool fabric was washed with deionized water repeatedly and dried at 50° C.

After treatment by the above process, the wool fabric has a felting rate of 9.21%, a weight loss rate of 10.5%, and a strength loss rate of 19.18%.

Compared with hydrogen peroxide pretreatment, urea produced during decomposition of urea peroxide in the treatment process can help the fiber swell, so that urea peroxide can oxidate the urea peroxide on lipids and the surface of scales better, being favorable for the subsequent anti-felting treatment.

Although the disclosure has been disclosed as above in preferred examples, it is not intended to limit the disclosure. Anyone familiar with the art can make various changes and modifications without departing from the spirit and scope of the disclosure. Therefore, the protection scope of the disclosure should be defined by the claims.

What is claimed is:

1. A method for anti-felting finishing of wool fabric with protease K, comprising the following steps: pretreating wool fabric or wool fiber with urea peroxide, blocking a cell membrane complex CMC with chitosan oligosaccharides, then treating the wool fabric or wool fiber with protease K, and washing the wool fabric or wool fiber with water, wherein the blocking of the cell membrane complex CMC with the chitosan oligosaccharides is that the chitosan oligosaccharides are bonded to the cell membrane complex CMC by ionic bonds and hydrogen bonds.

2. The method for anti-felting finishing of wool fabric with protease K of claim 1, comprising the following specific steps:
(1) pretreatment of fabric with urea peroxide: immersing wool fabric or wool fiber in 80-100° C. hot water for 0.5-1 h and taking it out; then treating the wool fabric or wool fiber in a solution comprising urea peroxide 10-50 mL/L, sodium pyrophosphate 1-3 g/L and a penetrant JFC 0.5-2 g/L at a liquor ratio of (20-50):1, a temperature of 40-70° C., and a pH of 5-9 for 1-4 h;
and after finishing, washing the wool fabric or wool fiber with water, and drying the wool fabric or wool fiber at 50-60° C.;
(2) treatment of fabric with protease K: immersing the wool fabric or wool fiber pretreated in step (1) in 80-95° C. hot water comprising chitosan oligosaccharides 0.5-2 g/L and urea 10-50 g/L at a liquor ratio of (20-50):1 for 0.5-1 h; and then immersing the wool fabric or wool fiber in a protease K solution at a temperature of 40-65° C., a pH of 6-10, and a liquor ratio of (20-50):1, for a treatment time of 2-24 h; and
(3) enzyme inactivation: inactivating the protease K, finally washing the wool fabric or wool fiber with water, and drying the wool fabric or wool fiber.

3. The method for anti-felting finishing of wool fabric with protease K of claim 2, wherein Ca²⁺ 0.5-2 mmol/L is added to the protease K solution.

4. The method for anti-felting finishing of wool fabric with protease K of claim 2, wherein in step (3), the washing with water is that the wool fabric or wool fiber after enzyme inactivation is washed with 90-100° C. hot water and normal temperature water sequentially once or twice.

5. The method for anti-felting finishing of wool fabric with protease K of claim 2, wherein the amount of the protease K added is 2-32 U/g_{fabric/fiber}.

6. The method for anti-felting finishing of wool fabric with protease K of claim 4, wherein the amount of the protease K added is 2-32 U/g_{fabric/fiber}.

7. The method for anti-felting finishing of wool fabric with protease K of claim 1, wherein the wool fabrics comprises any one of all-wool gabardine, serge, and valitin worsted woolen fabric, or any one of all-wool gabardine, serge, and valitin woolen fabric.

8. The method for anti-felting finishing of wool fabric with protease K of claim 4, wherein the wool fabrics comprises any one of all-wool gabardine, serge, and valitin worsted woolen fabric, or any one of all-wool gabardine, serge, and valitin woolen fabric.

9. The method for anti-felting finishing of wool fabric with protease K of claim 5, wherein the wool fabrics comprises any one of all-wool gabardine, serge, and valitin worsted woolen fabric, or any one of all-wool gabardine, serge, and valitin woolen fabric.

10. The method for anti-felting finishing of wool fabric with protease K of claim 2, comprising the following specific steps:
fabric variety: all-wool gabardine fabric;
(1) pretreatment of fabric with urea peroxide: immersing the wool fabric in 90° C. hot water for 1 h; then treating the wool fabric in a solution comprising urea peroxide 30 mL/L, sodium pyrophosphate 1.5 g/L and a penetrant JFC 1 g/L at a liquor ratio of 35:1, a temperature of 50° C. and a pH of 8 for 1 h; and after finishing, washing the wool fabric with water repeatedly, and drying the wool fabric at 50° C.;
(2) treatment of fabric with protease K: immersing the pretreated wool fabric in 90° C. hot water comprising chitosan oligosaccharides 1 g/L and urea 20 g/L for 1 h; and then immersing the wool fabric in a protease K solution (16 U/g_{fabric}) with Ca²⁺ 1 mmol/L added, at an enzyme solution temperature of 50° C., a pH of 8 and a liquor ratio of 25:1 for 6 h; and
(3) inactivating the enzyme at 80° C. for 10 min, after finishing, washing the wool fabric with 90° C. hot water and normal temperature water sequentially twice, and drying the wool fabric at 50° C.

11. The method for anti-felting finishing of wool fabric with protease K of claim 2, comprising the following specific steps:
fabric variety: valitin fabric;
(1) pretreatment of fabric with urea peroxide: immersing the wool fabric in 90° C. hot water for 1 h; then treating the wool fabric in a solution comprising urea peroxide 30 mL/L, sodium pyrophosphate 1.5 g/L and a penetrant JFC 1 g/L at a liquor ratio of 35:1, a temperature of 50° C. and a pH of 8 for 1 h; after finishing, washing the wool fabric with deionized water repeatedly; and drying the wool fabric at 50° C.;
(2) treatment of fabric with protease K: immersing the pretreated wool fabric in 90° C. hot water comprising chitosan oligosaccharides 1 g/L and urea 20 g/L for 1 h; and then immersing the wool fabric in a protease K solution (4 U/g_{fabric}) with Ca²⁺ 1 mmol/L added, at an enzyme solution temperature of 50° C., a pH of 8 and a liquor ratio of 25:1 for 4 h; and
(3) inactivating the enzyme at 80° C. for 10 min, after finishing, washing the wool fabric with 90° C. hot water and normal temperature water sequentially twice, and drying the wool fabric at 50° C.

12. The method for anti-felting finishing of wool fabric with protease K of claim 2, comprising the following specific steps:
fabric variety: valitin fabric;
(1) pretreatment of fabric with urea peroxide: immersing the wool fabric in 90° C. hot water for 1 h; then treating the wool fabric in a solution comprising urea peroxide 10 mL/L, sodium pyrophosphate 2 g/L and a penetrant JFC 2 g/L at a liquor ratio of 50:1, a temperature of 70° C. and a pH of 6 for 2 h; after finishing, washing the wool fabric with deionized water repeatedly, and drying the wool fabric at 50° C.;
(2) treatment of fabric with protease K: immersing the pretreated wool fabric in 90° C. hot water comprising chitosan oligosaccharides 2 g/L and urea 40 g/L for 1 h; and then immersing the wool fabric in a protease K solution (25 U/g_{fabric}) with Ca²⁺ 2 mmol/L added, at an enzyme solution temperature of 65° C., a pH of 10 and a liquor ratio of 20:1 for 4 h; and
(3) inactivating the enzyme at 80° C. for 10 min, after finishing, washing the wool fabric with 90° C. hot water and normal temperature water sequentially twice, and drying the wool fabric at 50° C.

13. Wool fabric or wool fiber finished by the method for anti-felting finishing of wool fabric with protease K of claim 1.

14. An anti-felting finishing solution for wool fabrics, comprising a solution A, a solution B and a solution C, wherein the solution comprises urea peroxide 10-50 mL/L, sodium pyrophosphate 1-3 g/L and a penetrant JFC 0.5-2 g/L; the solution B comprises chitosan oligosaccharides 0.5-2 g/L and urea 10-50 g/L; and the solution C is a protease K solution comprising Ca²⁺ 0.5-2 mmol/L.
